(19) United States
(12) Patent Application Publication
(10) Pub. No.: US 2010/0065764 A1
(43) Pub. Date: Mar. 18, 2010

(54) Remote control system to set hot cold water ratio of an electronic faucet

(75) Inventor: Murat Canpolat, Antalya (TR)

Correspondence Address: Murat Canpolat, Ogretmen Evleri Mahallesi, 901. Sokak, No: 17/5, Arapsuyu, Antalya, 07070, TR

(73) Assignee: Murat Canpolat, Antalya (TR)

(21) Appl. No.: 12/553,109

(22) Filed: Sep. 3, 2009

Related U.S. Application Data
(60) Provisional application No. 61/232,013, filed on Aug. 7, 2009.

(51) Int. Cl. F16K 31/02

(52) U.S. Cl. 251/129.04

(57) ABSTRACT

The present invention relates controlling ratio of mixing hot and cold water of an electronic faucet by setting a mixing valve with an electronics actuator using two infrared sensors without touching to the faucet or its accessories. The system consists of two infrared sensors (IR), red and blue light emitting diodes, a mixing valve, an actuator, a temperature sensor and its display. When a user enters effective working range of the left or the right IR sensors the actuator actuate the mixing valve to change hot/cold water mixing ratio of the faucet. The IR sensors located on the left side of the faucet increase hot water ratio and IR sensor located on the right side of the faucet increase cold water ratio of the faucet when a user enters the effective working range of the IR sensors.

### CROSS-REFERENCE TO RELATED APPLICATION

This application claims priority of U.S. provisional application No. 61/232,013 filed on Aug. 7, 2009 entitled “A remote control system to set hot cold water ratio of an electronic faucet”

### BACKGROUND OF THE INVENTION

Mixing valves are used to obtain a desired water temperature by changing the ratio of hot and cold water of an electronically controlled faucet. Mixing valve has two inlet ports and one output port. One of the inlet ports is connected to the cold water supply and the other one is connected to the hot water supply. The outlet port of the mixing valve is connected to the faucet. Mixing valve under the sink can be set either by mechanical means or an electronics actuator, to obtain a desired water temperature. The mechanical actuator can be used in two different ways to control the faucet water temperature. In the first way, a user sets the mixing valve by rotating a lever next to the faucet to obtain a desired water temperature. In the second way, a user can set the electronic actuator by touching an electronic touch panel to obtain a desired water temperature. A mechanical actuator can also be permanently set for a predefined water temperature and a user can not change the water temperature in this case

A user has to touch either a lever of a mechanical actuator or a touch panel of an electronic actuator to obtain a desired water temperature. Touching a part of a faucet is not desirable for hygienic concerns.

### BRIEF SUMMARY OF THE INVENTION

The present invention relates to setting a mixing valve by an electronics actuator using two infrared sensors to obtain a desired water temperature from an electronic faucet. The actuator sets the mixer valve based on the signal received from either left or right infrared sensors. If the actuator receives the signal from the left sensors, it actuates the mixing valve to increase the ratio of hot water. If the actuator receives the signal from the right sensor, it actuates the mixing valve to increase the ratio of the cold water with respect to the previous position of the mixing valve. The left infrared sensor sends signal to the actuator when the user enters the effective range of the left sensor. Similarly, the right sensor sends the signal to the actuator when the user enters the effective range of the right sensor. The ratio of hot and cold water can be monitored by light emitting diodes (LEDs). Blue LEDs are placed next to the right sensors and red LEDs are placed next to the left sensor. A temperature sensor is positioned at the output port of the mixer valve to sense the water temperature and to display it at the top of the faucet. So a user can change hot and cold water ratio without touching the faucet or its accessories in real time.

### BRIEF DESCRIPTION OF THE DRAWINGS

FIG. 1 is a schematic view of the system illustrating installation position.

FIG. 2 is a block diagram of the system electronics of the first embodiment, which includes sensors and electronics of setting cold/hot water ratio, water flow control and temperature sensor.

FIG. 3 is a block diagram of the system electronics of the second embodiment, which includes sensors and electronics of setting cold/hot water ratio and temperature sensor.

### DETAILED DESCRIPTION OF THE INVENTION

The present invention concerns a water temperature control system of an electronic faucet without touching the faucet or its accessories. The system consists of two infrared sensors, an electronic actuator, an electronic microcontroller unit, a mixing valve, a temperature sensor and its display and blue LEDs and red LEDs. One of the infrared sensors and a group of four red LEDs are located on the left site of the electronics faucet. The other infrared sensor and a group of four blue LEDs are located on the right site of the electronic faucet. Mixing valve and electronic actuator is beneath or behind the faucet housing wall or sink. The outlet port of the mixing valve is connected to the inlet port of the solenoid-actuated pilot valve. One of the inlet ports of the mixing valve is connected to a hot water supply and the other one is connected to a cold water supply. When a user enters the effective range of the right or the left sensors the actuator actuates the mixing valve. The ratio of the number of the active blue LEDs to the number of active red LEDs is the indicator of the mixing ratio of the cold to hot water. For example, if the all the four blue LEDs are on and all of the red LEDs are off, the mixing valve provides only cold water to the faucet. The possible LEDs configuration and cold-hot water mixing ratio are given in Table. 1

TABLE 1
Active LEDS and cold hot water mixing ratio

| | |
|---|---|
| Number of the active LEDS | Cold/hot water mixing ratio |

| Blue | Red | Cold | Hot |
|---|---|---|---|
| 0 | 4 | 0 | 1 |
| 1 | 3 | 1/4 | 3/4 |
| 2 | 2 | 2/4 | 2/4 |
| 3 | 1 | 3/4 | 1/4 |
| 4 | 0 | 1 | 0 |

In the first row of the table all of the blue LEDs are off and all the red LEDs are on, and the faucet water is completely coming from the hot water supply. In the second row only one blue LED is on, and three red LEDs are on, in that case ⅓ of the faucet water is from the cold water supply and ⅔ is from the hot water supply. In the third row, two red and two blue LEDs are on. Therefore mixing ratio of cold-hot water is half. In the fourth row, three blue LEDs and one red LED are on, therefore ⅔ of the faucet water is from the cold water supply and ⅓ is from the hot water supply. In the last row, four blue LEDs on and all the red LEDs are off, indicating that all of the faucet water is from cold water supply.

When a user enters the effective range of the left sensor for a second, one red LED turns on and one blue LED turns off. For example, if the faucet water is completely cold at the beginning, all the red LEDs are off and blue LEDs are on, when a user enters the effective range of the left sensor for four second, all four blue LEDs turn off and all the red LEDs turn on. This means that the faucet water is only from hot water supply. When a user enters the effective range of the right sensor, red LEDs turn off and blue LEDs turn on.

A user first looks at the water temperature indicator located on the top of the faucet, when he/she decides to increase or decrease the cold/hot water ratio, he/she enters the effective range of the right or left sensors. After setting the cold/hot water ratio, the user enters the effective range of the infrared sensor control solenoid-actuated pilot valve to turn the water on. Default setting of the mixing valve provides equals amounts of cold and hot water after use of 10 seconds, in that case only two blue and two red LEDs are on.

The automatic faucet with a remote temperature control unit is particularly suitable for public lavatories for sanitary reasons.

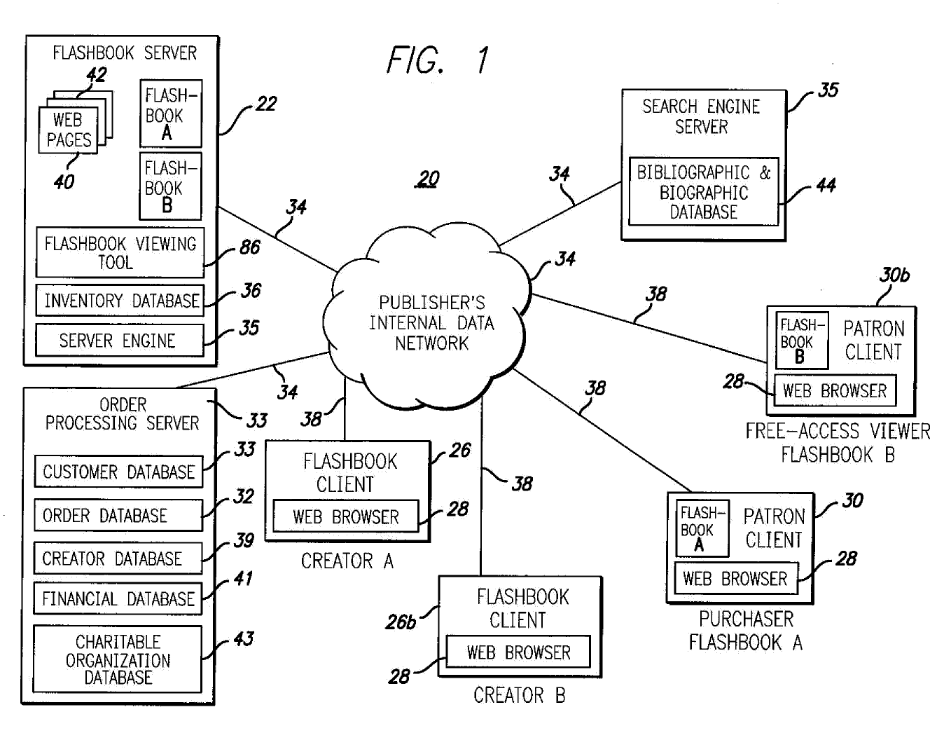

The system is illustrated in FIG. 1. An infrared sensor 10 and a group of four red LEDs 30 placed on left side of the faucet 130. If a user enters the effective range of the infrared sensor 10 ratio of the hot water increases and cold water decreases. Another infrared sensor 20 and a group of four blue LEDs 40 are placed on the right side of the faucet 130. When a user enter the effective range of the sensor 20, the ratio of cold water increases and hot water decreases. The infrared sensor 110 that is located on the middle of the faucet controls the solenoid valve 120 that turns water flow on and off. The sensors 10, 20 and 110 are connected to an electronic control unit 60 by the electric signal transmission cables 50, 51 and 52. The electronic control unit 60 controls the actuator 70 by sending a signal via a transmission line 61. When the actuator 70 receives a signal from the electronic control unit 60, it moves the mixing valve 80 and changes the cold/hot water ratio. The electric control unit 60 sends an electric signal via a transmission line 63 to the solenoid valve 120 to turn water flow on and off. A temperature sensor 151 is located at the outlet port of the mixing valve to sense the temperature. The sensor is connected to the electronic control unit 60 by an electric signal transmission line 62. The electronic control unit 60 is connected to the temperature display 150 by an electric signal transmission line 53. Hot water supply 90 and cold water supply 100 are connected to the inlet ports of the mixing valve 80. Outlet port of the mixing valve 80 is connected to the inlet port of the solenoid valve 120 by a water pipe 140. Outlet port of the solenoid port is connected to the faucet 130 by a water pipe 160. Default set of the mixing valve provides equal amounts of hot and cold water to the faucet. After use of the faucet, the actuator sets the mixing valve to its default position within 10 seconds. In that way, a new user can get completely hot or cold water by entering for two seconds within the effective range of the left sensor 10 or right sensor 20.

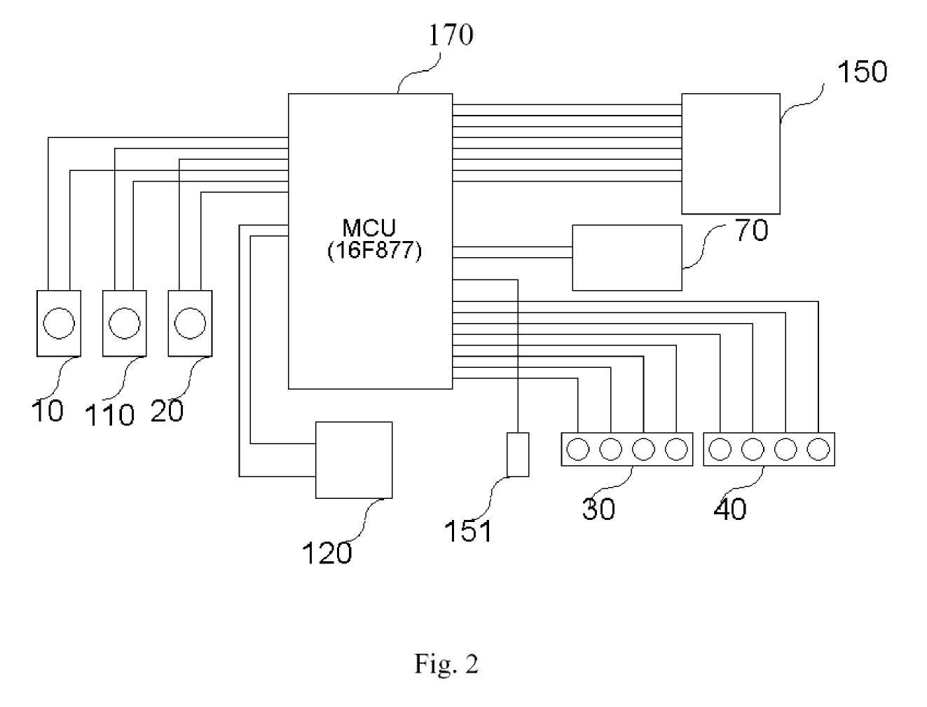

FIG. 2 is the electronic block diagram for first embodiment of the system. It includes sensors and electronics of the system that can control ratio of the mixing water and water flow, and a temperature sensor 151 with its display 150. The system includes three infrared sensors 10, 110, 20 a microcontroller unit (MCU) 170. MCU 170 controls the solenoid valve 120, actuator 70 and temperature display 150. Red LEDS 30 and blue LEDs 40 receive signals from the MCU 170 and turn on and off based on the signals from the sensors located on the left and right of the faucet.

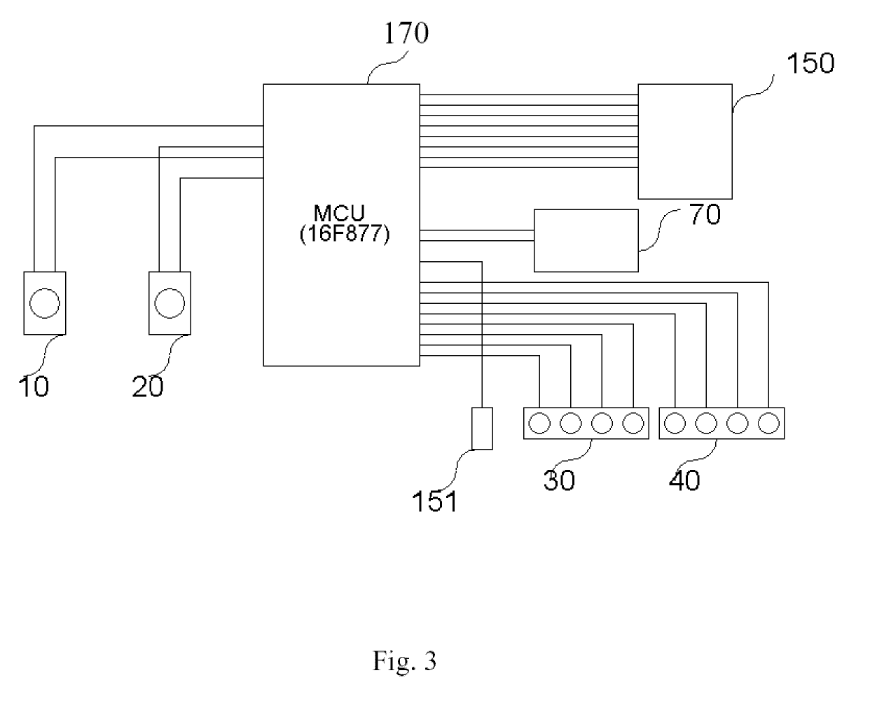

FIG. 3 is the electronic block diagram of the second embodiment of the system. The second embodiment can be installed on an electronic faucet that already has an infrared sensor and solenoid valve to control the water flow of a faucet. Therefore, the second embodiment of the system includes only two infrared sensors 10, 20 to control mixing ratio of hot/cold water and one temperature sensor 151. All the sensors are connected to a MCU 170. The MCU 170 controls the actuator 70, turns on and off blue LEDS 30 and red LEDs 40 and sends signal to the temperature display 150.

What is claim is:

1. Remote control of an actuator that actuates a mixing valve to change hot/cold water mixing ratio of an electronic faucet.

2. In claim 1, remote control comprises electromagnetic and ultrasonic sensors

3. In claim 2, infrared sensor has at least one infrared emitter and at least one infrared receiver that detect the infrared waves back reflected from an object to control hot/cold water mixing ratio.

4. In claim 2, ultrasonic sensor has at least one source of sound wave (mechanical waves) and at least one sound detector that detects back reflected sound waves from an object to control hot/cold water mixing ratio.

5. When an object enters the effective range of the electromagnetic sensors in claim 3, or ultrasonic sensors in claim 4, sensor sends a signal to a micro-controller unit (MCU) to controls the actuator actuate mixing valve based on the signal length to change hot/cold water mixing ratio.

6. In claim 5, the actuator has four steps of rotation, for one second signal duration, the actuator moves one step forward or backward based on the signal received from sensor located on the left or right side of the faucet.

7. In claim 6, duration of the signal that moves the actuator one step changes between 0.001 s to 120 second.

8. In claim 6, actuator may control hot/cold water ratio with a number of steps from 1 to 1000.

9. In claim 6, the actuator sets the mixing valve to its default position to provide equal amount hot and cold water to the faucet within time from 1 second to 300 seconds after use.

10. Four red LEDs are placed next to the infrared sensor located on the left side of the faucet and four blue LEDs are placed next to the infrared sensor located on the right side of the faucet.

11. In claim 10, ratio of the number of red LEDs turned on to the blue LEDs turned on is a ratio of the hot/cold water mixing ratio.

12. In claim 10, if all red LEDs turned on, the faucet water comes from only the hot water supply.

13. In claim 10, if all blue LEDs turned on, the faucet water comes from only the cold water supply.

14. Placing a temperature sensor on the outside surface of the output port of the mixing valve and a temperature display on top of the faucet.

15. In claim 10, numbers of the blue and red LEDs may vary from 1 to 1000.
